(19) United States
(12) Patent Application Publication
(10) Pub. No.: US 2002/0143854 A1
(43) Pub. Date: Oct. 3, 2002

(54) Fault-tolerant mobile agent for a computer network

(75) Inventors: Stefan Pleisch, Zurich (CH); Andre Schiper, Bussigny (CH)

Correspondence Address: IBM CORPORATION, INTELLECTUAL PROPERTY LAW DEPT., P. O. BOX 218, YORKTOWN HEIGHTS, NY, 10598, US

(73) Assignee: International Business Machines Corporation, Armonk, NY (US)

(21) Appl. No.: 09/821,168

(22) Filed: Mar. 29, 2001

(51) Int. Cl. G06F 15/16

(52) U.S. Cl. 709/202

(57) ABSTRACT

The invention is directed to a method of operating a mobile agent that travels through a network of a number of computers. The mobile agent is executed in a sequence of stages wherein each stage comprises a set of places. The method comprises the steps of executing the mobile agent in at least one of the set of places of a respective one of the stages, evaluating in which place of the respective stage the mobile agent has been executed successfully, agreeing on this place among the set of places, aborting and/or undoing any operation in connection with the mobile agent in any other place of the respective stage, and moving the modified mobile agent resulting from the successful execution to the next stage.

### FIELD AND BACKGROUND OF THE INVENTION

The invention relates to a method of operating a mobile agent that travels through a network of a number of computers.

Such a mobile agent system is known, e.g. from A. Mohindra, A. Purakayastha and P. Thati: Exploiting non-determinism for reliability of mobile agent systems”, in Proc. of the Int. Conf. On Dependable Systems and Networks, pages 144-153, New York, June 2000.

One concern in connection with such a mobile agent system is the fact that failures may lead to blocking or a complete loss of the mobile agent. This problem may be solved by replication of the mobile agent. However, this leads to the so-called exactly-once execution problem which has to be fulfilled. In the above mentioned prior art document, this problem is solved by detecting multiple mobile agents at the end of any execution and by undoing all effects of multiple executions. However, such an undoing function is not simple and often limits the overall system throughput.

### SUMMARY OF THE INVENTION

It is an object of the invention to provide a method of operating a mobile agent which is fault-tolerant without being too complex.

This object is solved by one aspect of the present invention, which provides a method of operating a mobile agent that travels through a network of a number of computers, wherein the mobile agent is executed in a sequence of stages and wherein each stage comprises a set of places, the method comprising the following steps: executing the mobile agent in at least one of the set of places of a respective one of the stages, evaluating in which place of the respective stage the mobile agent has been executed successfully, agreeing on this place among the set of places, aborting and/or undoing any operation in connection with the mobile agent in any other place of the respective stage, and moving the modified mobile agent resulting from the successful execution to the next stage.

As well, this object is solved by the computer program product that contains instructions implementing the steps of the foregoing method, and still further, whereby the foregoing method steps are managed by a fault-tolerance enabler (FTE) which is independent of the mobile agent.

The invention uses the replication of the mobile agent so that a set of places is available within a sequence of stages in which the mobile agent is executed. In order to prevent blocking and to solve the exactly-once execution problem, the invention includes the idea to model the execution of the mobile agent and its replication as a sequence of agreement problems.

According to the invention, the mobile agent is executed in at least one of the set of places of a respective one of the stages. Then, it is evaluated in which place of the respective stage the mobile agent has been executed successfully. After this step, any operation in connection with the mobile agent in any other place of the respective stage is aborted and/or undone. Finally, the modified mobile agent resulting from the successful execution is moved to the next stage.

This method ensures that only exactly one execution of the mobile agent within the set of places of the respective stage is committed whereas all other possible executions are aborted and/or undone.

The implementation of the inventive method may preferably be done by a so-called fault-tolerance enabler (FTE) which may be programmed as an independent component but which may then travel to the places of the stages together with the mobile agent.

Further advantages and embodiments of the invention are apparent from the further claims and/or from the following description of the drawings.

### BRIEF DESCRIPTION OF THE DRAWINGS

Examples of the invention are depicted in the drawings and are described in detail below by way of example. It is shown in

FIG. 1a: a schematic representation of a method of operating a mobile agent according to an embodiment of the invention;

FIG. 1b: a schematic representation of the method of

FIG. 1a comprising a failure;

FIG. 2: a schematic block diagram of a consensus method according to an embodiment of the invention; and

FIG. 3: a schematic block diagram of an architecture of the mobile agent according to an embodiment of the invention.

All the figures are for sake of clarity not shown in real dimensions, nor are the relations between the dimensions shown in a realistic scale.

### DETAILED DESCRIPTION OF EMBODIMENTS OF THE INVENTION

In the following, the various exemplary embodiments of the invention are described.

A mobile agent is a computer program that acts autonomously on behalf of an agent owner or user and that travels through a network of a number of computers. Failures in such a system may lead to a blocking of the execution of the mobile agent or to a partial or complete loss of the mobile agent. As well, the agent owner often does not know whether the mobile agent is actually lost due to the failure or whether its execution has only been delayed due to slow computers. The agent owner may then believe that the mobile agent has been lost when in fact it has not been, or he waits for the mobile agent to finish when it has failed.

This uncertainty may be removed by a mobile agent with a fault-tolerant execution. The mobile agent then either reaches its destination or at least notifies a problem.

Such fault-tolerance may be gained by replicating the mobile agent. Replication of the mobile agent is similar to the addition of redundancy and enables the mobile agent to continue its execution despite failures. The blocking of the mobile agent, therefore, is prevented.

However, the replication of the mobile agent may lead to the violation of the so-called exactly-once execution property of the execution of the mobile agent. If, for example, a mobile agent is executed on a first computer and fails, then the first computer may survive, however, comprising modifications performed by the failing mobile agent. A replication of the mobile agent is then executed on a second computer performing modifications of the second computer. This results in modifications in the first and the second computer which contradicts the exactly-once execution property. This property is also violated if the failure of a mobile agent is detected, however, the mobile agent has actually not failed. In this case, the unreliable failure detection leads to a double execution of the mobile agent which, as mentioned, contradicts the exactly-once execution property.

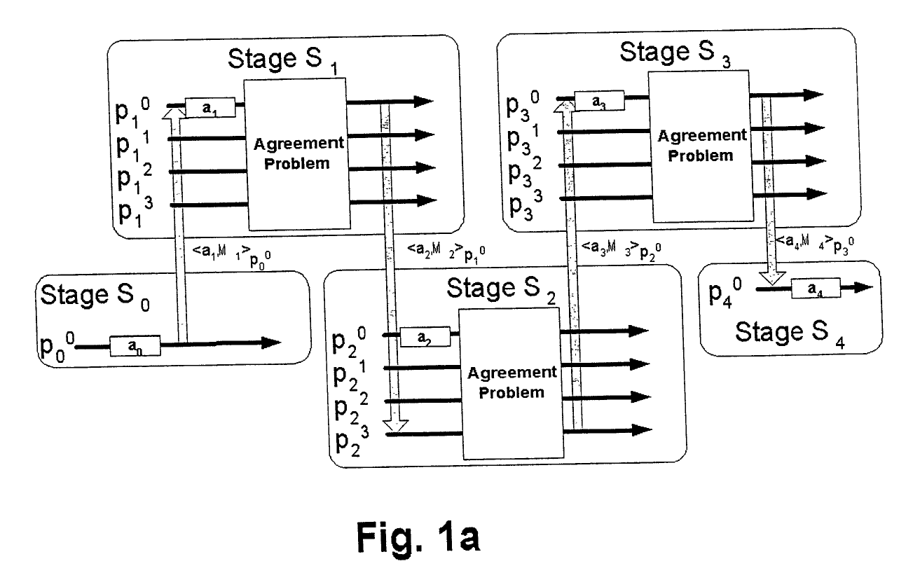

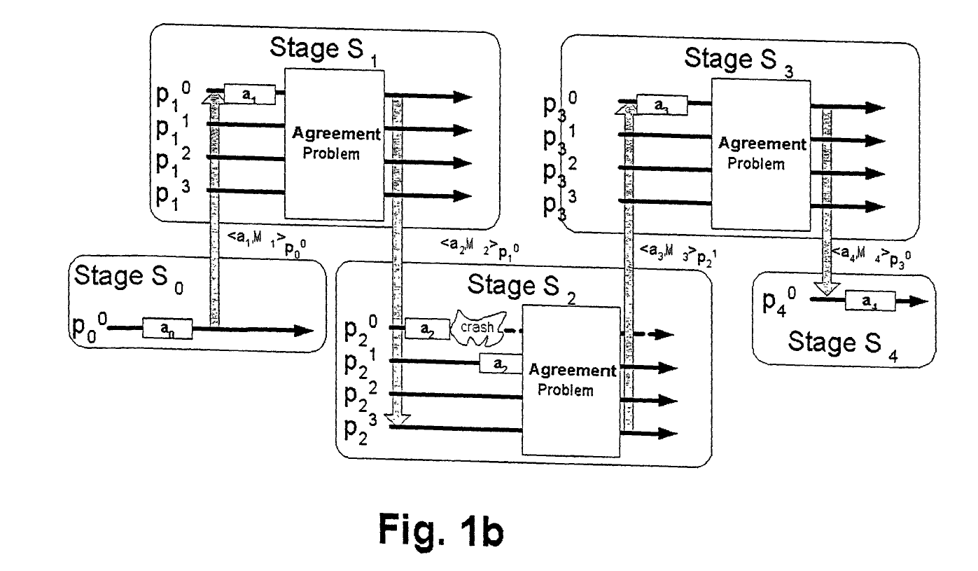

The idea is to model the execution of the mobile agent and its replication as a sequence of agreement problems. For that purpose, the following assumptions are taken and explained now in connection with FIG. 1a.

As already described, a mobile agent aᵢ executes on a sequence of computers; wherein i=0 . . . n. A place pᵢ provides a logical execution environment for the mobile agent aᵢ wherein each computer may host multiple places pᵢ. The execution of the mobile agent aᵢ at a place pᵢ is called a stage Sᵢ. The replicas of the mobile agent aᵢ execute on different places pᵢ^{j} within one and the same stage Sᵢ. Two stages Sᵢ and Sᵢ₊₁ are separated by a move operation of the mobile agent aᵢ. The places pᵢ^{j} where the first and the last execution of the mobile agent aᵢ take place are called the source p₀⁰ and the destination pₙ⁰ of the mobile agent aᵢ, which may be identical.

According to FIG. 1a, the mobile agent a₀ is executed in the place p₀⁰ of stage S₀ which is the source of the mobile agent. Then, after successfully executing the mobile agent a₀, the agreement problem is solved by a decision <a₁, M₁>p₀⁰ in which a₁ is the resulting mobile agent after executing the mobile agent a₀ at the place p₀⁰ of the stage S₀, M₁ is the set of places p₁^{j} of the next stage S₁, and p₀⁰ is that place of the stage S₀ which has successfully executed the mobile agent a₀. The evaluation of the aforementioned decision will be explained later.

Due to this decision, the mobile agent a₁ enters the next stage Sᵢ at the place pᵢ^{j} and is executed there. According to FIG. 1a, the stage S₁ comprises the further places p₁¹, p₁² and p₁³ in which replicas of the mobile agent a₁ may be executed. However, after successfully executing the mobile agent a₁ at place p₁⁰ of the stage S₁, the agreement problem is solved at once, i.e. it is agreed among the set M₁ of places p₁⁰, p₁¹, p₁² and p₁³ that the place p₁⁰ has executed the mobile agent a, successfully. This leads to a decision <a₂, M₂>p₁⁰ in which a₂ is the resulting mobile agent after executing the mobile agent a₁ at stage S₁, M₂ is the set of places p₂^{j} of the next stage S₂, and p₁⁰ is that place of the stage S₁ which has successfully executed the mobile agent aᵢ.

According to FIG. 1a, this procedure is continued through the sequence of stages Sᵢ until the destination of the mobile agent is reached. There, the mobile agent a₄ enters the stage S₄ and is executed in the only place p₄⁰.

In FIG. 1a, no failure occurs. This means that none of the computers fails, none of the places fails, and the execution of none of the mobile agents fails. Moreover, no incorrect failure detection is present. Therefore, the mobile agent is always executed in the first place of any of those stages which comprise more than one place, i.e. in the places p₁⁰, p₂⁰ and p₃⁰ of the stages S₁, S₂ and S₃. Therefore, these places p₁⁰, p₂⁰ and p₃⁰ are also part of the respective decision after the execution of the mobile agents in the respective stages.

In contrast thereto, FIG. 1b comprises a failure of the place p₂⁰ of the stage S₂. This is depicted in FIG. 1b with the expression “crash”.

When the place p₂¹ detects the failure of the place p₂⁰, it executes a replica of the mobile agent a₂. It has to be mentioned that the place p₂⁰ is the first one in the sequence of the set M₂ of the places p₂⁰, p₂¹, p₂² and p₂³ of the stage S₂ which executes the mobile agent a₂. The next place p₂¹ is able to monitor the execution of the mobile agent a₂ in the preceding place p₂⁰. Upon detection of a failure of the mobile agent a₂ or the place p₂⁰, the next place p₂¹ starts executing the replica of the mobile agent a₂.

After successfully executing the replica of the mobile agent a₂ in the place p₂¹ of the stage S₂, the agreement problem is solved. It is agreed among the set M₂ of places p₂⁰, p₂¹, p₂² and p₂⁰ in which place the mobile agent has been executed successfully. As described, this is the place p₂⁰. This leads to a decision <a₃, M₃>p₂¹ in which a₃ is the resulting mobile agent after executing the mobile agent a₂ at stage S₂, M₃ is the set of places p₃^{j} of the next stage S₃, and p₂¹ is that place of the stage S₂ which has successfully executed the mobile agent a₂.

The important difference between FIG. 1a and FIG. 1b, therefore, is that the decision after stage S₂ of FIG. 1b comprises the place p₂¹ as successfully executing the mobile agent a₂ whereas the decision after the stage S₂ of FIG. 1a comprises the place p₂⁰. The decision of FIG. 1b, therefore, recognizes the fact that the execution of the mobile agent a₂ failed in the place p₂⁰ of stage S₂ of FIG. 1b.

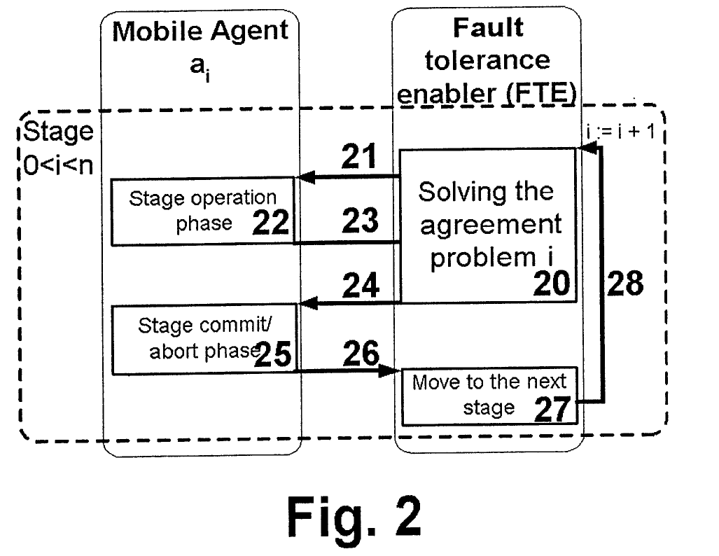

The decisions that are taken in each of the stages Sᵢ of the FIGS. 1a and 1b are evaluated by using a consensus method which will be explained now in connection with FIG. 2.

FIG. 2 shows a stage Sᵢ which may be any of the stages shown in FIGS. 1a and 1b. The stage Sᵢ comprises the corresponding mobile agent aᵢ and a so-called fault-tolerance enabler (FTE) as two independent components.

If the stage Sᵢ is entered from a preceding stage, the FTE starts to solve the agreement problem for this stage Sᵢ (see block 20). For that purpose, the block 20 initiates (see arrow 21) the operation of the stage Sᵢ (see block 22), so that the mobile agent aᵢ is executed in the places pᵢ^{j} of the stage Sᵢ sequentially. As soon as one of the places pᵢ^{j} successfully executes the mobile agent aᵢ, this is recognized by the block 20 of the FTE (see arrow 23). This successful place is agreed upon among the set Mᵢ of places pᵢ^{j} and is then called the primary place pᵢ^{prim}.

The block 20 of the FTE then confirms to all places pᵢ^{j} of the stage Sᵢ that the primary place pᵢ^{prim} is committed and that all other places have to abort and/or undo any operation in connection with the mobile agent aᵢ.

Except for the primary place pᵢ^{prim}, any operation in connection with the mobile agent aᵢ is then aborted and/or undone (see block 24 and block 25). As soon as this phase is finished, this is recognized by the FTE (see arrow 26).

The decision of the agreement problem of the current stage Sᵢ is then present in the FTE (see block 27). This decision was already described above. The aforementioned primary place pᵢ^{prim} is identical with those places of FIGS. 1a and 1b which have successfully executed the respective mobile agent as. In particular, with regard to FIG. 1b, the primary place pᵢ^{prim} of stage S₂ is the successful place p₂¹ and not the failing place p₂⁰.

The block 27 of the FTE then moves the resulting mobile agent a₁₊₁ together with the generated decision, in particular together with the set Mᵢ₊₁ of the places pᵢ₊₁^{j} of the next stage Sᵢ₊₁ to this next stage Sᵢ₊₁ (see arrow 28). This move of the resulting mobile agent aᵢ₊₁ is performed as a reliable forward function.

For that purpose, each place pᵢ^{j} of stage Sᵢ sends a clone of the resulting mobile agent aᵢ₊₁ to all places pᵢ₊₁^{j} of the stage Sᵢ₊₁. In order to reduce communication overhead, it is possible that only the primary place pᵢ^{prim} of the stage Sᵢ sends the resulting mobile agent aᵢ₊₁, to all places pᵢ₊₁^{j} of the stage Sᵢ₊₁ and that all other places of the stage Sᵢ only verify whether the resulting mobile agent aⱼ₊₁ has arrived at the places p₁₊₁ ^{j} of the stage Sᵢ₊₁, e.g. by accessing the corresponding value in a repository of these places pᵢ₊₁^{j}.

As shown in FIG. 2, the block 20 of the FTE then starts to solve the agreement problem for this next stage Sᵢ₊₁.

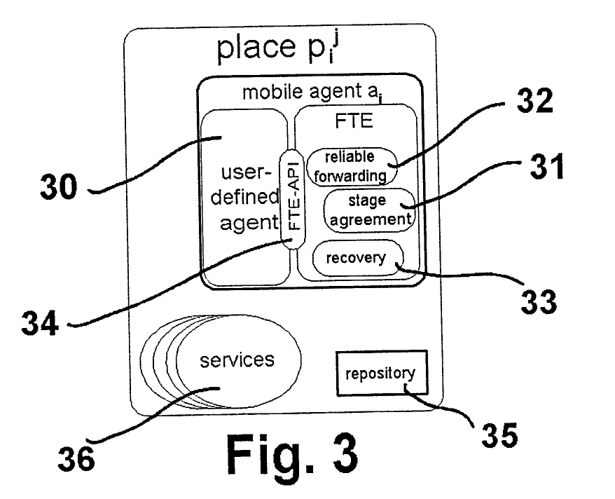

The described consensus method is implemented with a so-called agent-dependent architecture. As shown in FIG. 3, the FTE is integrated into the mobile agent aᵢ and travels with it to the sequential places pᵢ^{j}. Only one instance of the FTE exists per mobile agent aᵢ which is initialized by the user-defined agent 30 at the source of the mobile agent aᵢ.

The FTE is composed of a stage agreement component 31, a reliable forwarding component 32 and a recovery component 33. The stage agreement component 31 performs the consensus method, the reliable forwarding component 32 is responsible for reliably forwarding the resulting mobile agent aᵢ₊₁ to the next stage, and the recovery component 33 handles any necessary recovery in case the mobile agent a fails or arrives too late at one of the places pᵢ^{j}.

The FTE provides a FTE-specific application programming interface 34 for the communication with the user-defined agent 30. The respective place pᵢ^{j} provides a repository 35 and further services 36. The repository 35 is a location where place-specific information may be stored temporarily. For example, the decision generated by the FTE may be stored in the repository 35, in particular the primary place pᵢ^{prim}. This information can then be kept until all other places of the respective stage Sᵢ are aware of this decision. The information may then be discarded after a certain time.

1. A method of operating a mobile agent that travels through a network of a number of computers, wherein the mobile agent is executed in a sequence of stages and wherein each stage comprises a set of places, the method comprising the following steps:
executing the mobile agent in at least one of the set of places of a respective one of the stages,
evaluating in which place of the respective stage the mobile agent has been executed successfully,
agreeing on this place among the set of places,
aborting and/or undoing any operation in connection with the mobile agent in any other place of the respective stage, and
moving the modified mobile agent resulting from the successful execution to the next stage.

2. The method of claim 1 wherein the steps are repeated for any one of the sequence of stages.

3. The method of claim 1 wherein the mobile agent is executed sequentially in the set of places of the respective stage, and wherein the mobile agent is not executed anymore in subsequent places after successful execution in one of the set of places and agreement on this successful execution.

4. The method of claim 1 wherein a decision is generated in each stage including at least one of a primary place that corresponds to the place in which the mobile agent has executed successfully, the set of places of the next stage to which the modified mobile agent is moved, and/or the resulting modified mobile agent.

5. The method of claim 4 wherein at least one of the primary place and/or the set of places of the next stage and/or the resulting modified mobile agent is confirmed to at least all other places of the respective stage except the primary place.

6. The method of claim 4 wherein at least one of the primary place and/or the set of places of the next stage and/or the resulting modified mobile agent is moved to all places of the next stage.

7. The method of claim 6 wherein the move is performed as a reliable forward function.

8. The method of claim 1 wherein the steps are managed by a fault-tolerance enabler (FTE) which is independent of the mobile agent.

9. The method of claim 8 wherein the FTE travels with the mobile agent to the set of places of the respective stage.

10. A computer program product comprising program code means for use for operating a mobile agent that travels through a network of a number of computers, wherein the mobile agent is executed in a sequence of stages and wherein each stage comprises a set of places, the computer program product comprising instructions for:
executing the mobile agent in at least one of the set of places of a respective one of the stages,
evaluating in which place of the respective stage the mobile agent has been executed successfully,
agreeing on this place among the set of places,
aborting and/or undoing any operation in connection with the mobile agent in any other place of the respective stage, and
moving the modified mobile agent resulting from the successful execution to the next stage.

11. Computer program product according to claim 10, wherein the program code means is stored on a computer-readable medium.

12. A network of a number of computers in which a mobile agent is travelling through, wherein the network comprises a sequence of stages, wherein each stage comprises a set of places, and wherein the mobile agent is executed in at least one of the set of places of a respective one of the stages, the network comprising means for evaluating in which place of the respective stage the mobile agent has been executed successfully, means for agreeing on this place among the set of places, means for aborting and/or undoing any operation in connection with the mobile agent in any other place of the respective stage, and means for moving the modified mobile agent resulting from the successful execution to the next stage.
